(19) United States
(12) Patent Application Publication
(10) Pub. No.: US 2013/0228230 A1
(43) Pub. Date: Sep. 5, 2013

(54) VACUUM ACTUATED VALVE

(71) Applicant: FIELD SPECIALTIES, INC., Hitchcock, TX (US)

(72) Inventors: Michael John Joy, Newbury Park, CA (US); James Steven Carlisle, Santa Fe, TX (US); Lawrence Neill, Camarillo, CA (US)

(73) Assignee: FIELD SPECIALTIES, INC., Hitchcock, TX (US)

(21) Appl. No.: 13/784,818

(22) Filed: Mar. 4, 2013

Related U.S. Application Data
(60) Provisional application No. 61/605,932, filed on Mar. 2, 2012.

(51) Int. Cl. G05D 11/02

(52) U.S. Cl. CPC G05D 11/02
USPC 137/88

(57) ABSTRACT

A vacuum actuated valve assembly includes a valve body housing a butterfly valve configured to be connected to a vapor containing fluid source having a static pressure; a linear rack and pinion assembly; an externally exhausted pneumatic actuator having a body with a first end and a second end, an internal piston, an external piston rod shaft having a third end away from the body of the actuator, and a spring located over the external piston rod shaft and fitted in between the second end and a stopper near the third end. The externally exhausted pneumatic actuator is configured to be operated by the static pressure of the vapor in the fluid source. The rack and pinion assembly is coupled to the third end of the external piston rod shaft, and configured to operate the butterfly valve.

### CROSS-REFERENCE TO RELATED APPLICATION(S)

This application claims priority to and the benefit of U.S. Provisional Application No. 61/605,932, filed Mar. 2, 2012, entitled VACUUM ACTUATED VALVE-Provisional Patent Description, the entire content of which is incorporated herein by reference.

### TECHNICAL FIELD

The present disclosure is related to a control device to regulate the flow and manage the static pressure between a negative pressure source and a fluid material source.

### BACKGROUND

There are many industrial applications that require the transfer of materials from one vessel, pipeline and other conveyance and storage device to another. Frequently, those materials include vapors and liquids and the transfer is accomplished by the employment of the negative-pressure of vacuum-based systems. The vacuum-based systems utilize blowers, vacuum pumps, engines and other devices capable of generating the negative pressure or vacuum required to effect the movement of the material of interest. In many instances it is desired to have a constant flow rate of the fluid being transferred, whether it is in the form of liquid, vapor or combinations thereof. Because vapor is compressible, and liquids are not as compressible, it is challenging to maintain a constant flow for a given vacuum. In addition, since each vacuum-based system may have a different discharge capacity, a given flow rate that works well for one vacuum-based system may not work well for another. Or a given flow rate that works well for one vacuum-based system for one material may not work well for another material due to the different mix of vapor and liquid.

Therefore, there is a need for a novel system and method to regulate the flow of the material according to its ever changing liquid and vapor ratio. There is a further need for an automated self-adjusting valve that opens and closes based on vacuum differential to maintain constant vacuum and flow.

### SUMMARY

The present invention provides a vacuum actuated valve assembly, which is a mechanical automatic flow and pressure control device that can be used to regulate the flow of a fluid material during a transfer process employing negative pressure and manage the static pressure between the negative pressure or vacuum source and the original material containment point when inserted in the transfer line.

In one embodiment of the invention, a vacuum actuated valve assembly includes a valve body housing a valve configured to be connected to a vapor containing fluid source having a static pressure; a conversion mechanism; an externally exhausted pneumatic actuator having a body with a first end and a second end, an internal piston, an external piston rod shaft having a third end away from the body of the actuator, and a spring located over the external piston rod shaft and fitted in between the second end and a stopper near the third end. The externally exhausted pneumatic actuator is configured to be operated by the static pressure of the vapor in the fluid source. The conversion mechanism is coupled to the third end of the external piston rod shaft, and configured to operate the valve. In one embodiment of the invention, the valve is a butterfly valve. In another embodiment of the invention, the conversion mechanism is a linear rack and pinion mechanism.

In another embodiment of the invention, a method of using the vacuum actuated valve assembly includes the steps of setting up the spring with a spring tension; connecting the vacuum actuated valve assembly to the fluid source through an inlet side; and applying vacuum to the vacuum actuated valve assembly.

### BRIEF DESCRIPTION OF THE DRAWINGS

FIG. 1 is a perspective view of a schematic illustration of one embodiment of a vacuum actuated valve assembly.

FIG. 2 is an end view of a schematic illustration of a butterfly valve.

FIG. 3 is a cut-away side view of a pneumatic actuator.

FIG. 4 is a block diagram showing one embodiment of the invention.

FIG. 5 is a perspective view of a schematic illustration of another embodiment of a vacuum actuated valve assembly.

FIG. 6 is a schematic illustration of various parts of one embodiment of a pneumatic actuator.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein.

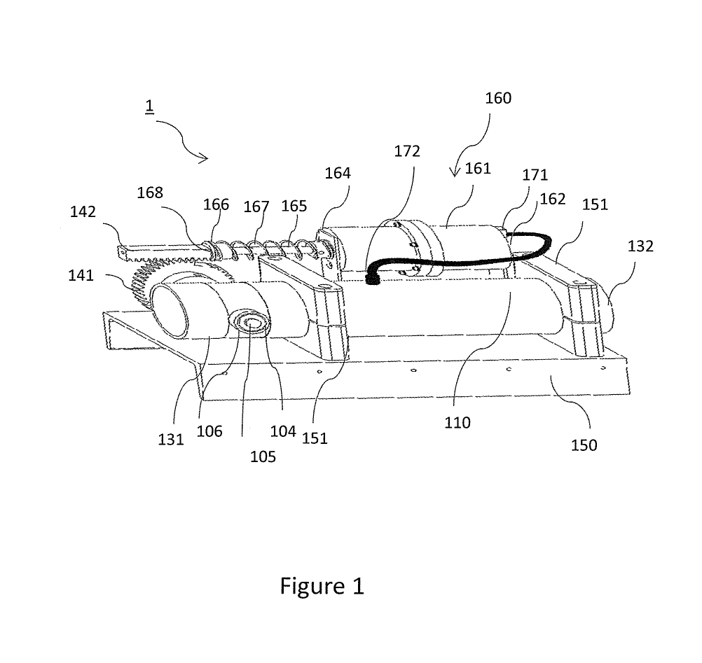

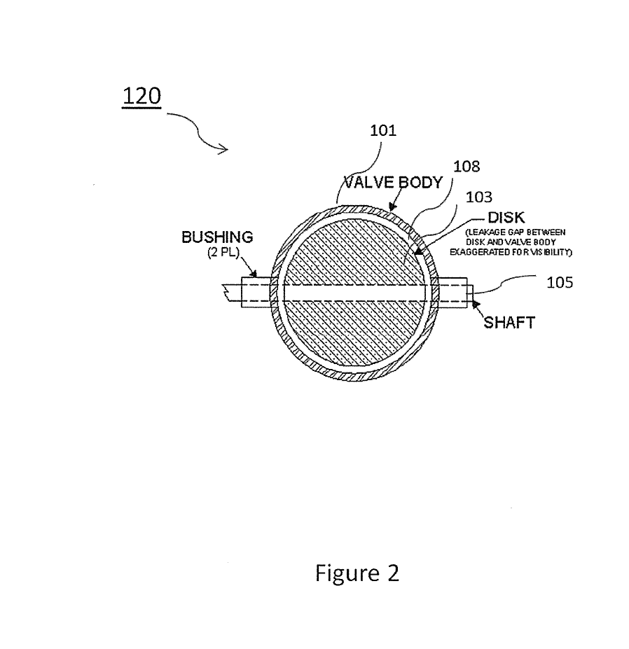

Referring to FIGS. 1, 2 and 3, an embodiment of a vacuum actuated valve assembly 1 includes a cylindrical valve body 110, which houses an internal butterfly valve 120 located towards an outlet side 131. The butterfly valve 120 includes a disk 103 (see FIG. 2) and a shaft 105 that passes through the middle of the disk horizontally.

The butterfly valve rotates around the shaft between a fully opened position and a fully closed position. The fully opened position is achieved when the disk is rotated to a horizontal position, parallel to the direction of fluid flow. The fully closed position is achieved when the disk is rotated to a vertical position, perpendicular to the direction of the fluid flow. The amount of opening of the valve is therefore controlled by the central axial rotation of the shaft, one degree of freedom, and acts as a flow restrictor inside the valve body.

In a fully closed position, the disk leaves a leakage gap 108 with the internal wall of the valve body and allows for a small amount of bypass flow. This configuration will preclude the need for the use of vacuum-break technology to open the butterfly valve against large negative pressures or a full vacuum, and will always allow for a minimal flow through the valve when vacuum is applied.

The shaft 105 of the butterfly valve passes through a pair of through-holes located on two diametrical ends of the valve body, and extends to seals 104 and bearings 106 located on the outside of the valve body 110 to retain the shaft 105 and allow for its rotation. On the other side of the valve body, the shaft extends through the bearing, and provides a locating and mounting surface for a pinion gear 141, which is attached thereto via its mounting hub. While the embodiment shown depicts a butterfly valve, it should be understood that other types of valves that can be moved to regulate the flow of fluid may be used.

The valve body 110 is affixed to a mounting plate 150 with various clamps 151. Another part of the vacuum actuated valve assembly, an externally exhausted linear pneumatic actuator 160, is also mounted on the mounting plate 150. The mounting plate allows the vacuum actuated valve assembly to be fastened in place to an external fixture during use.

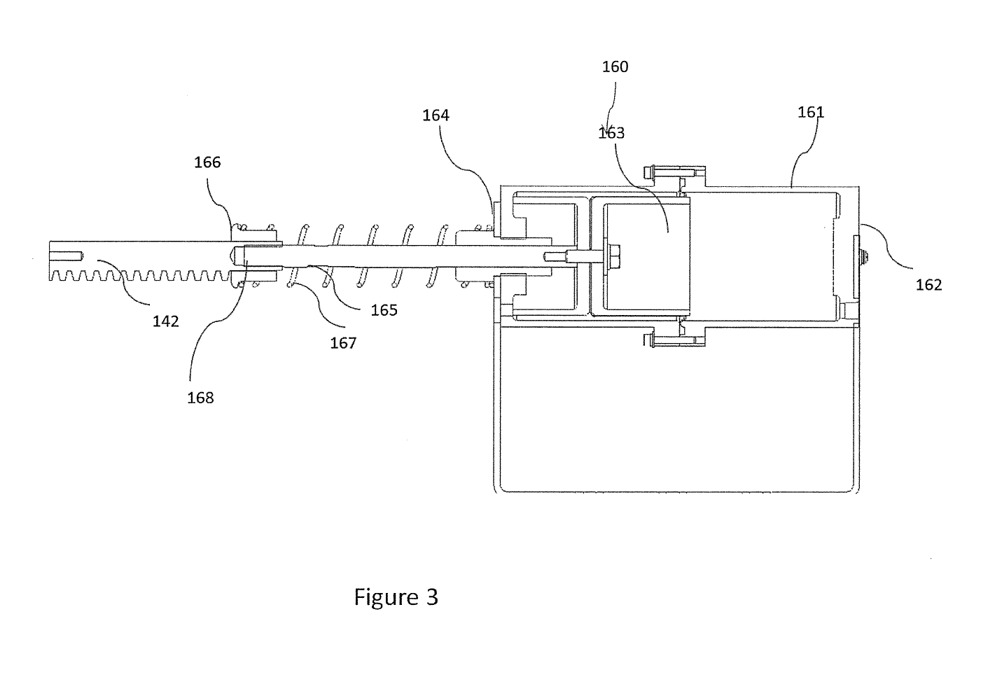

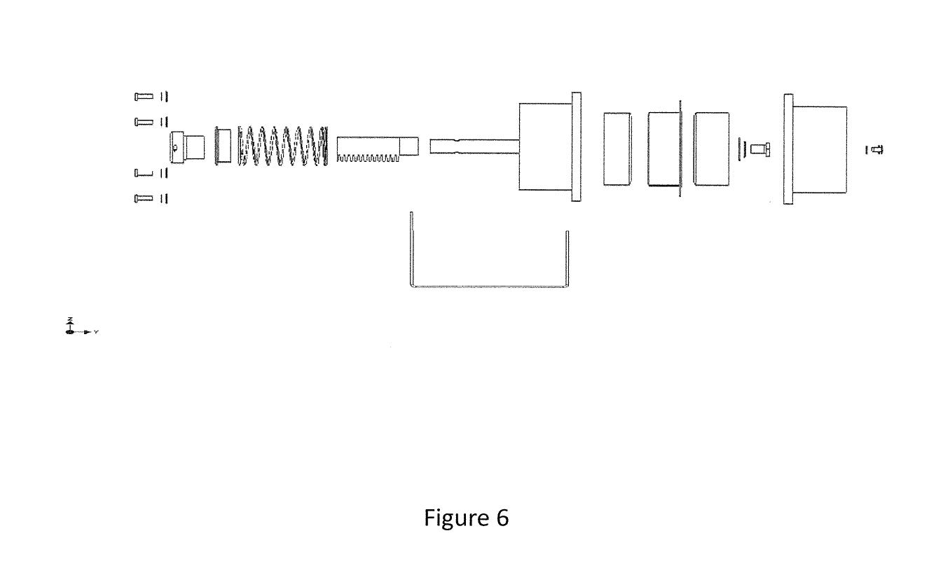

The externally exhausted linear pneumatic actuator has a body 161, a piston 163, an external piston rod shaft 165, and a cylindrical control spring 167, among other parts as shown in FIG. 3 and FIG. 6. The body of the pneumatic actuator has a first end 162 and a second end 164 opposing the first end. The external piston rod shaft 165 is connected to the piston 163 on one end, extending out of the second end of the pneumatic actuator 164, and has a free end 168. The spring 167 is located over and around the external piston rod shaft 165 and is held in place by acting against the second end 164 of the pneumatic actuator body, and an adjustable stopper 166 located around the end 168 of the external piston rod shaft. When the piston 163 is pushed towards the end 164 and away from the end 162, it pushes the external piston rod shaft 165 accordingly. The spring 167 moves with the external piston rod on the end near the stopper 166, but is anchored on the other end 164 held against the second end of the pneumatic actuator 164. The spring is therefore effectively acting against the force of the actuator. Through adjusting the spring tension, the force required to overcome the spring tension can be controlled and in turn, the pressure for the internal piston to move can be controlled. The spring tension can be adjusted to allow for variable resistance in the force required to move the piston. The position of stopper 166 can be adjusted to adjust the spring tension.

Although a coil spring is shown in the depicted embodiment, it should be understood that other types of biasing mechanisms may be used to adjust the tension that much be overcome to move the piston. For example, leaf springs or electronic solenoids may be used to generate a biasing force.

A linear rack gear 142 is affixed as an extension of the free end 168 of the external piston rod shaft. The linear rack gear 142 locates and meshes with a pinion gear 141 which is attached to one end of the butterfly valve shaft 105. Through this conversion mechanism, the linear motion of the pneumatic cylinder is translated to rotational motion and allows for the pneumatic actuator to control the movement of the butterfly valve. It should be understood that other types of conversion mechanisms may be used to translate changes in static pressure, which moves the piston in the pneumatic cylinder, into movement that will open or close a valve.

The inlet port 171 of the pneumatic cylinder is located on the first end 161 of the body 160. It is connected to the inlet side of the vacuum actuated valve body at a fitting 172. The pneumatic cylinder may be fitted with an internal flexible diaphragmatic seal if required by the process to maintain internal cleanliness. It may also be fitted with a diaphragm captured by two piston halves, or a piston with o-rings.

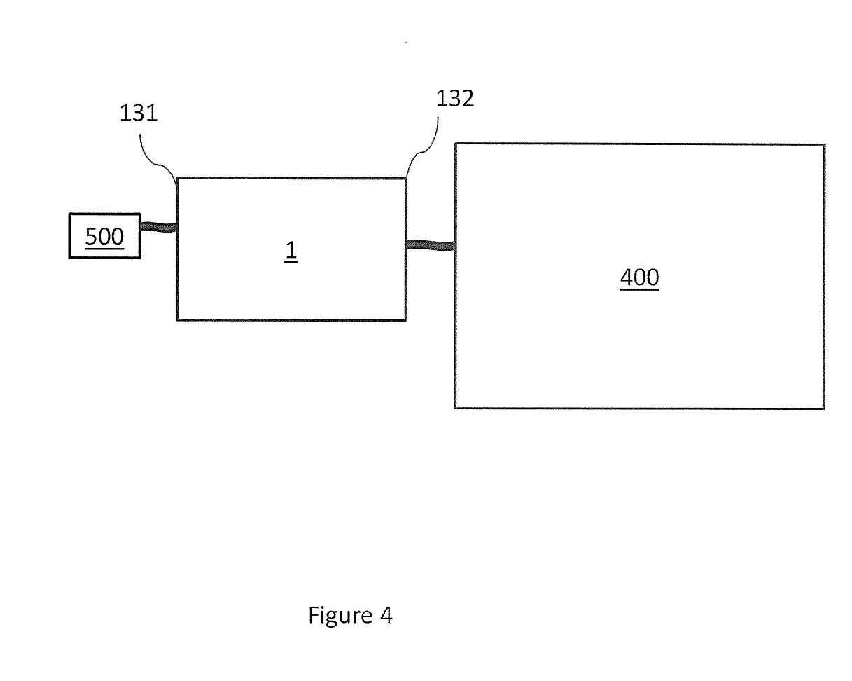

In using the vacuum actuated valve assembly, the fluid source 400 is connected to the inlet side 132 of the assembly 1, and a vacuum source 500 is connected to the outlet side 131 of the assembly 1, as shown in FIG. 4. After applying vacuum, fluid flows through the cylindrical valve body 110 from the inlet, passing through the butterfly valve and the outlet side, towards the vacuum source.

When a fluid source flows through the vacuum actuated assembly, the static pressure generated by the flow through of the fluid material acts upon the piston in the pneumatic cylinder. When the fluid source is rich in vapor, the static pressure can be higher than the spring tension, the static pressure will generate movement of the piston 163, the external piston shaft 165, and the linear rack gear 142. The pinion gear 141 in turn rotates the shaft 105, which further rotates the butterfly disk 103 and changes its position towards a more closed position. The flow into the vacuum source is reduced and the saturation of the vacuum source is avoided accordingly. In the meantime, the vacuum inside the body of the vacuum actuated valve body is also reduced because of the more closed position of the disk 103, and the flow rate of the fluid into the assembly will be reduced accordingly. This in turn will reduce the static pressure that works against the piston 163. When the pressure is reduced to be below the spring tension of the spring, the spring will push the piston in the reverse direction. Through action of the spring, the piston may move in the reverse direction towards the end 162, pulling the external piston shaft 165 and the linear rack gear 142 towards the reverse direction as well. The pinion gear 421 in turn rotates in the reverse direction, and further rotates the butterfly disk and changes its position towards a more opened position. The flow into the vacuum source is then increased, and the static pressure increases again inside the body 110. Therefore, by adjusting the spring tension, one can properly balance the flow and pressures between the material source and the negative pressure or the vacuum source, while ensuring that negative pressure or vacuum of the system is maintained without reaching the operating limits of the negative pressure or vacuum source device during the fluid transfer operation.

In the embodiment shown, the spring tension may be adjusted manually by adjusting the position of stopper 166 or by changing the spring used in the assembly. However, it should be understood that the spring tension may be configured to be automatically controlled to allow for use of a control system to operate the valve.

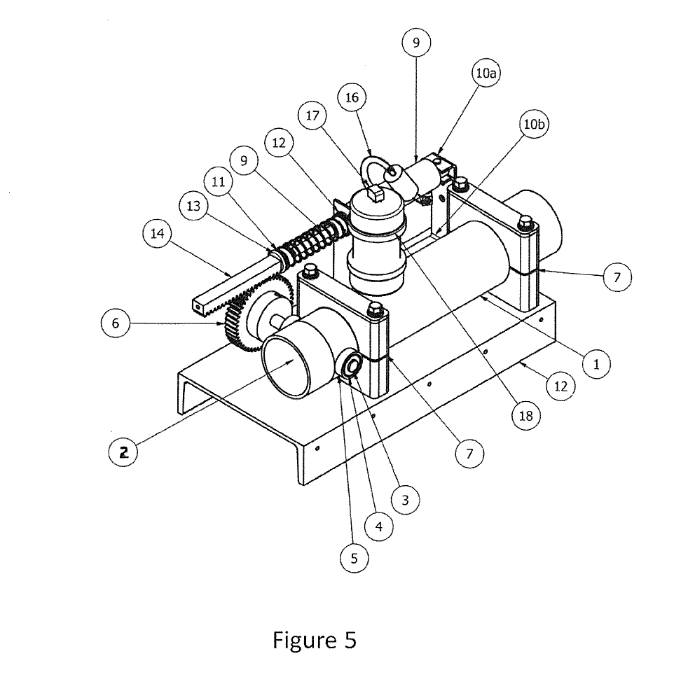

FIG. 5 shows another exemplary embodiment of the vacuum actuated valve assembly. The vacuum actuated valve assembly is similar to the ones described previously, with the exception that the inlet port of the pneumatic cylinder is connected via a mechanical tubing to a connection fitting located in a reservoir on the inlet side of the cylindrical valve body. The reservoir acts to condition the fluid before the vapor reaches the pneumatic actuator. In particular, the vacuum actuated valve assembly in this embodiment of the invention includes a cylindrical valve body 1, which houses an internal butterfly valve 2 located towards an outlet side of the cylindrical valve body. The butterfly valve 2 includes a disk and a shaft 3 that passes through the middle of the disk horizontally. The shaft passes through a pair of through-holes located on two diametrical ends of the valve body, and extends to seals 4 and bearings 5 located on the outside of the valve body. On the other side of the valve body, the shaft extends through the bearing, and provides a locating and mounting surface for a pinion gear 6. The valve body is affixed to a mounting plate 12 with various clamps 7, which also has an externally exhausted linear pneumatic actuator 9 attached. The pneumatic actuator has a pneumatic actuator body 12, an external piston rod shaft 19 connected with an internal piston, and a cylindrical control spring 11, among other parts as shown in FIG. 5. The spring is located over and around the external piston rod shaft and is held in place by acting against the body of the pneumatic actuator and a stopper 13 located around the free end of the external piston rod shaft. A linear rack gear 14 is attached to the free end of the external piston rod shaft, which meshes with the pinion gear 6 that is connected to the butterfly valve shaft. The inlet port of the pneumatic cylinder is connected via a mechanical tubing 16 to a connection fitting 17 located in a reservoir 18 on the inlet side of the cylindrical valve body. The pneumatic actuator may be fitted with an internal flexible diaphragmatic seal if required to maintain internal cleanliness.

Other types of valves besides the butterfly valve and other types of conversion mechanisms beyond the rack-and-pinion mechanism can be used in the vacuum actuated valve assembly.

Although limited embodiments of the vacuum actuated valve assembly have been specifically described and illustrated herein, many modifications and variations will be apparent to those skilled in the art. Accordingly, it is to be understood that vacuum actuated valve assemblies constructed according to principles of this invention may be embodied other than as specifically described herein. The invention is also defined in the following claims and equivalents thereof.

What is claimed is:

1. A vacuum actuated valve assembly, comprising:
a valve body housing a valve configured to be connected to a fluid source comprising a vapor having a static pressure;
a conversion mechanism;
an externally exhausted pneumatic actuator having a body with a first end and a second end, an internal piston, an external piston rod shaft having a third end away from the body of the actuator, and a spring located over the external piston rod shaft and fitted in between the second end and a stopper near the third end,
wherein the externally exhausted pneumatic actuator is configured to be operated in response to the static pressure of the vapor, the conversion mechanism is coupled to the third end of the external piston rod shaft, and configured to control the amount of opening of the valve.

2. The vacuum actuated valve assembly of claim 1, wherein the valve is a butterfly valve.

3. The vacuum actuated valve assembly of claim 1, wherein the conversion mechanism is a linear rack and pinion mechanism.

4. The vacuum actuated valve assembly of claim 1, wherein the valve body is configured to be connected to a vacuum source at an outlet side opposite to an inlet side connected to the fluid source.

5. The vacuum actuated valve assembly of claim 2, wherein the butterfly valve is configured to allow a small bypass flow when fully closed.

6. The vacuum actuated valve assembly of claim 2, wherein the butterfly valve has a shaft, and the shaft is coupled to a linear rack and pinion assembly.

7. The vacuum actuated valve assembly of claim 1, wherein the spring has an adjustable spring tension.

8. The vacuum actuated valve assembly of claim 1, wherein the fluid source further comprises a liquid.

9. A method of using the vacuum actuated valve assembly of claim 1, comprising:
setting up the spring with a spring tension;
connecting the vacuum actuated valve assembly to the fluid source through an inlet side; and
applying vacuum to the vacuum actuated valve assembly.

10. The method of claim 8, wherein the valve is a butterfly valve, and the conversion mechanism is a linear rack and pinion mechanism.
